(19) United States
(12) Patent Application Publication
(10) Pub. No.: US 2015/0286931 A1
(43) Pub. Date: Oct. 8, 2015

(54) METHODOLOGY FOR GENERATING POSSIBLE SOLUTIONS TO A PROBLEM

(71) Applicant: VISTASHIFT, INC., Penetanguishene (CA)

(72) Inventors: Ronald Scott Neumann, Penetanguishene (CA); Leslie Anne Eubanks, Vista, CA (US)

(21) Appl. No.: 14/677,885

(22) Filed: Apr. 2, 2015

Related U.S. Application Data
(60) Provisional application No. 61/974,570, filed on Apr. 3, 2014.

(51) Int. Cl. G06N 5/02; G06F 17/30

(52) U.S. Cl. CPC G06N 5/025; G06F 17/3053

(57) ABSTRACT

A method for use with a problem is provided. The method comprises activity on the part of a user. The user activity is structured to include a locate step involving a definition of the problem and ideation of factors that are material to the problem or to the utility of possible solutions to the problem. The user activity is also structured to include a navigate step following the locate step and involving a ranking of the factors in terms of the importance of the factor to the problem and the extent to which the factor can be controlled, a selection amongst the factors of factors that are relatively more important and/or relatively more susceptible to control, than the others, a review of the selected factors to identify viewpoints related to the factors, and a review of the selected factors from the identified viewpoints to ideate a body of insights.

### RELATED APPLICATIONS

This application claims priority under 35 U.S.C. §119(e) to U.S. Provisional Application Ser. No. 61/974,570 titled “METHODOLOGY FOR GENERATING POSSIBLE SOLUTIONS TO A PROBLEM,” filed Apr. 3, 2014, which application is incorporated herein by reference in its entirety.

### FIELD OF THE INVENTION

The invention relates to the field of problem solving.

### BACKGROUND OF THE INVENTION

It is well known to elucidate potential solutions to a problem by “brainstorming”. However, “brainstorming” results can be inconsistent.

### SUMMARY OF THE INVENTION

A method for use with a problem forms one aspect of the invention. The method comprises activity on the part of the user structured to include a locate step and a navigate step. The locate step involves the definition of the problem and ideation of factors that are material to the problem or to the utility of possible solutions to the problem.

The navigate step follows the locate step and involves:
a ranking of the factors in terms of the importance of the factor to the problem and the extent to which the factor can be controlled;
a selection amongst the factors of factors that are relatively more important and/or relatively more susceptible to control than the others;
a review of the selected factors to identify viewpoints related to the factors;
a review of the selected factors from the identified viewpoints to ideate a body of insights.

According to another aspect of the invention, the activity can be structure to further include an integrate step following the navigate step, the integrate step involving:
a review of the generated insights to ideate patterns and connections;
ideation of possible solutions to the problem; and
reviewing the possible solutions for merit to select solutions for further consideration.

According to another aspect of the invention, the integrate step can involve identification of criteria which must be met in order to constitute a viable solution and the review of the possible solutions for merit can involve the de-selection of those that fail to address the criteria.

According to another aspect of the invention, the activity can be further structured to include an investigate step preceding the integrate step, the investigate step involving:
in respect of each insight, a determination of importance and a determination as to the level of confidence in the accuracy of each insight;
an effort to verify insights determined to be relatively important and in respect of which there exists relatively low confidence as to accuracy; and
removal of insights from the body that have been proven inaccurate as part of the verification effort.

According to another aspect of the invention, in the navigate step, the relationship between the viewpoint and the factor:
is relatively close when the factor has been relatively lightly explored; and
is relatively distant when the factor has been relatively heavily explored.

According to another aspect of the invention, the viewpoint that is relatively close to the factor can be the viewpoint of the factor.

According to another aspect of the invention, the relatively distance relationship between the factor and the viewpoint can be a relationship defined by time, space or pattern.

Other advantages, features and characteristics of the invention will become apparent upon reviewing the following detailed description of an exemplary embodiment of the method and the appended drawings, the latter being briefly described hereinafter.

### BRIEF DESCRIPTION OF THE DRAWINGS

FIG. 1 shows the results of the Locate step in respect of a prophetic example and the exemplary embodiment of the method;

FIG. 2 shows the results of the Navigate step in respect of the factor selection process;

FIG. 2A shows the results of the Navigate step in respect of the viewpoint identification process;

FIG. 3 shows the results of the Navigate step in respect of the insight ideation process for Factors B, C, D;

FIG. 4 shows the results of the importance and confidence determination part of the Investigate step;

FIG. 5 shows the results of the Investigate step;

FIG. 6 shows the results of the criteria identification substep of the Integrate step;

FIG. 7 shows the results of the pattern and connection ideation substep of the Integrate step;

FIG. 8 shows the prophetic results generated from the possible solutions ideation step; AND

FIG. 9 shows the result of the reviewal for merit substep.

### DETAILED DESCRIPTION OF THE EXEMPLARY METHOD

As an initial matter, the exemplary method will be understood to:
be for use with a problem and by a group of people; and
comprise a Locate step, a Navigate step, an Investigate Step and an Integrate step.

The Locate step involves soliciting from the group of people:
a definition of the problem; and
factors that are viewed by the group as being material to the problem or to the utility of possible solutions to the problem.

For greater certainty, the term “soliciting” as indicated above is not intended to merely connote the delivery-up of existing thoughts of the group, but more generally to connote taking steps necessary to cause the user to ideate and document thoughts, which may be preconceived or conceived as part of the process.

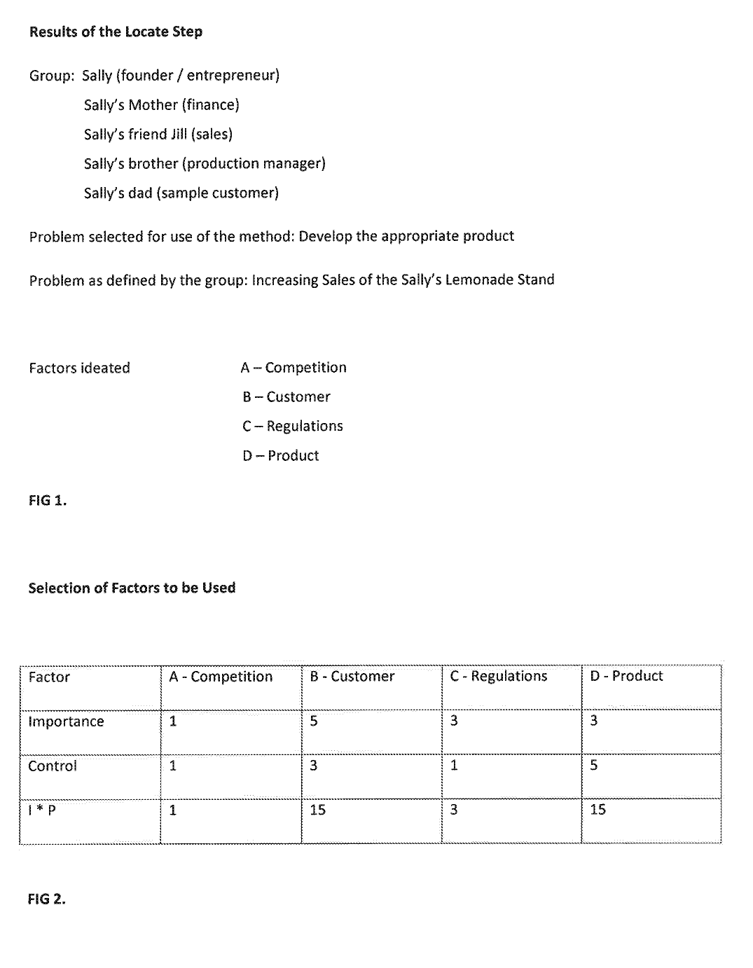

FIG. 1 shows the results of a prophetic example of a Locate exercise, for a group consisting of a founder (Sally) and friends and family members which have various roles in her enterprise. Herein, it will be seen that the problem that has been defined by the group is not the same as the problem in respect of which the method has been selected for use. This is a common occurrence and is neither desired nor discouraged.

The Navigate step follows the Locate step.

In the Navigate step:
the group ranks the solicited factors in terms of the importance of the factor to the problem and the extent to which the factor can be controlled, and selects factors for consideration those that are relatively more important and/or can be more controlled than others
the group considers each selected factor by looking at said each factor from
   a viewpoint that is closely related to the factor, when the factor has been relatively lightly explored by the group; and
   a viewpoint that is a far relation to the factor when the factor has been relatively heavily explored by the group
to ideate a body of insights.

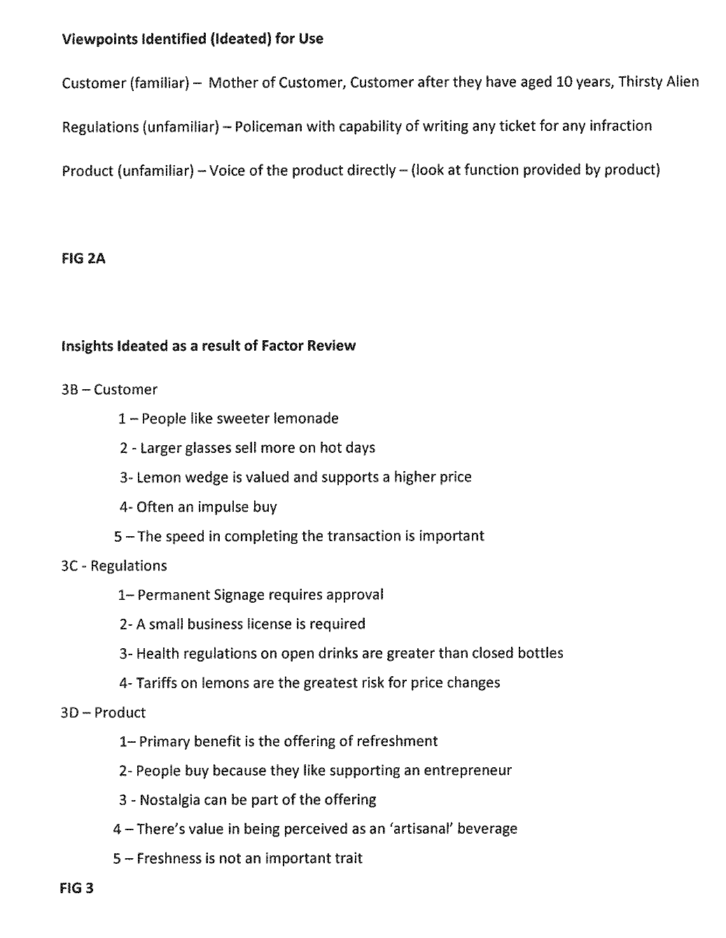

FIG. 2 shows the result of the prophetic factor selection process. Here, it will be seen that Factor A was viewed as relatively unimportant and relatively uncontrollable and thus was not selected. Factors B-D were all selected, as in this example, time permitted the consideration of Factor C, but if time for the session was constrained, Factor C would also not have been selected as the group saw Regulation to be relatively unimportant and relatively unsusceptible to control.

FIG. 2A shows the result of the viewpoint identification process. In this case, the factor “Customer” was something that had been previously heavily considered by the Group and accordingly, viewpoints relatively unrelated to the Customer were identified, i.e. the mother of the Customer, the Customer aged 10 years and a Thirsty Alien. The Factors “Regulation” and “Product” in this case had not been heavily considered previously by the group, and thus viewpoints relatively more related were chosen, i.e. a law enforcement officer with ticket writing capability was chosen for “Regulation” and “Voice of the Product” was chosen for “Product”.

From the foregoing, it will be understood that the relatedness of the viewpoint chosen for a factor is in inverse proportion to the extent to which the factor has been previously considered by the user of the method. It will also be appreciated that the viewpoint that is closely related to the factor can be the viewpoint of the factor, and the relationship between the factor and the viewpoint that is a distant relation to the factor can be a relationship defined by time, space or pattern, although neither of these outcomes is required.

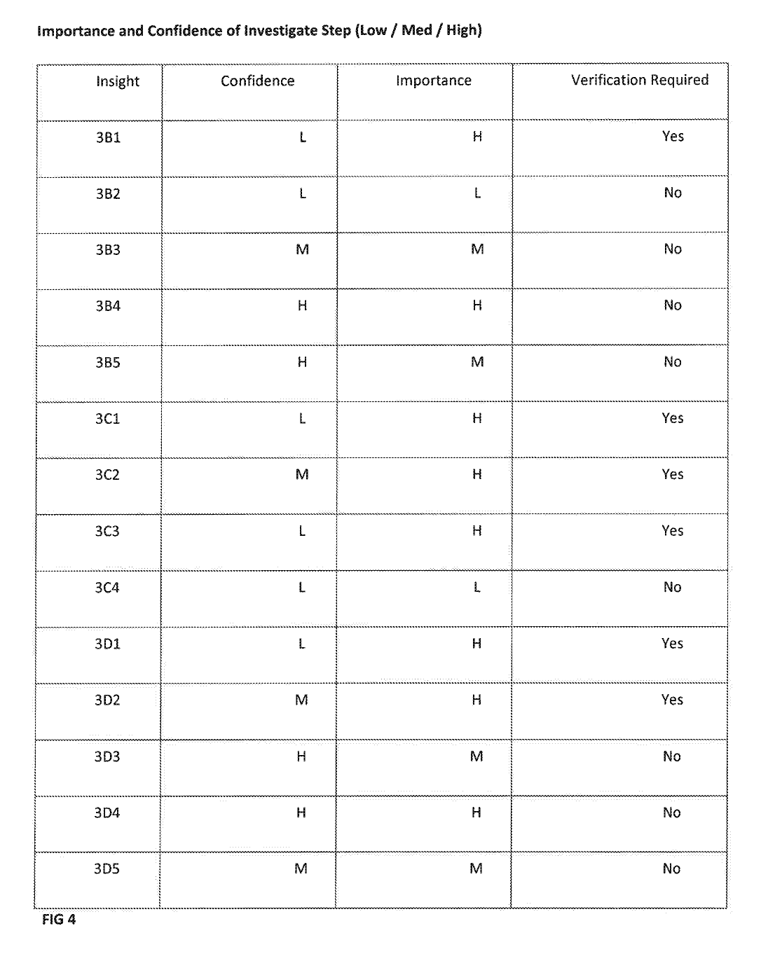

FIG. 3 shows the result of the insight ideation process for Factors B, C and D. In the Investigate Step, the group is caused to, in respect of each insight, make a determination of importance and make a determination as to the level of confidence the group has as to the accuracy of each insight. From this exercise, a short list of insights requiring verification is produced: these are the insights that are determined to be relatively important and in respect of which the group has relatively low confidence as to accuracy. The short list is indicated in FIG. 4. Thereafter, the group is tasked to verify the insights, and those that are verified but inaccurate are struck from the list and those that cannot be verified are identified as requiring further exploration, as indicated by FIG. 5.

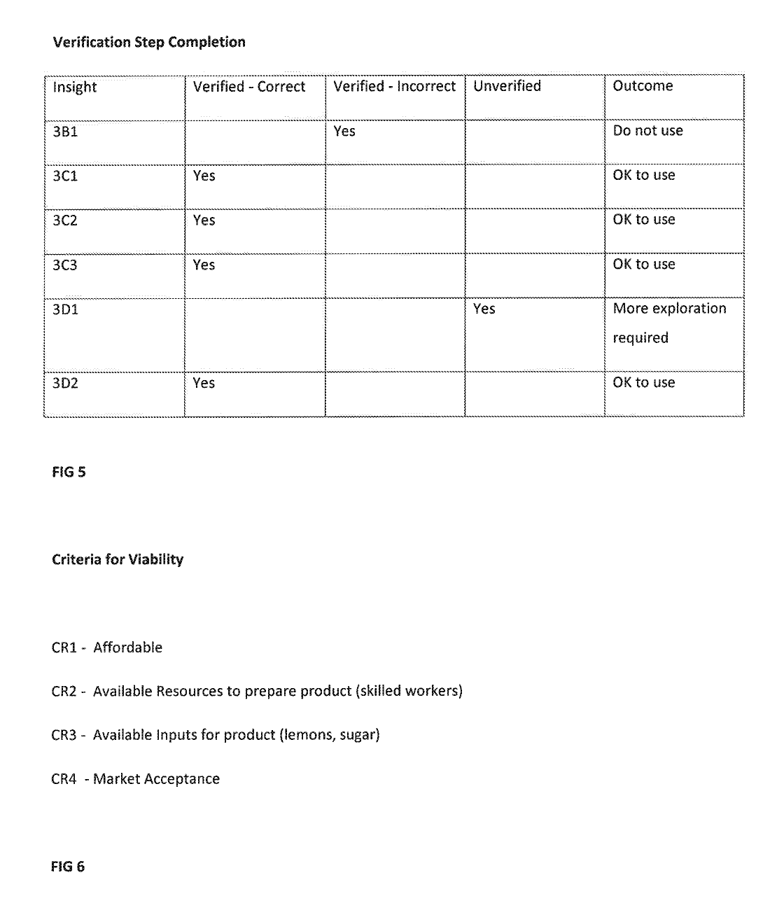

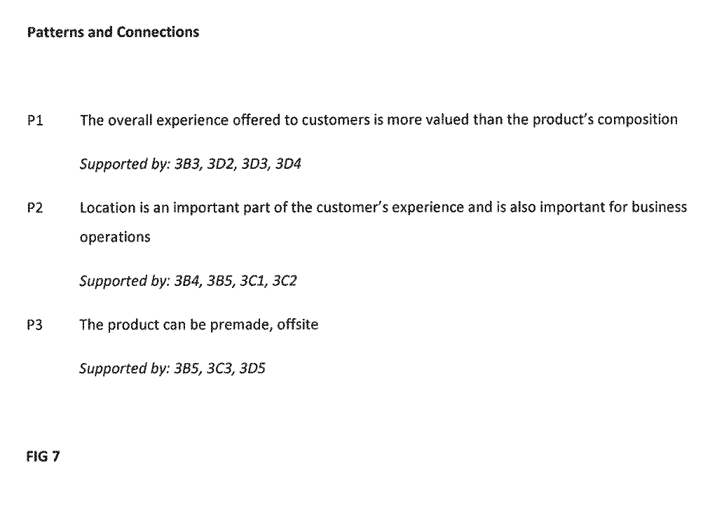

The exemplary Integrate step involves:
the identification of criteria that must be met in order to constitute a viable solution; the results of the prophetic example are shown in FIG. 6
a review of the ideated insights to ideate patterns and connections; a list of patterns and connections ideated in the prophetic example is shown in FIG. 7
ideating possible solutions to the problem; the results generated from the exercise are shown in FIG. 8
reviewing the possible solutions for merit and striking those from the list that fail to address the criteria

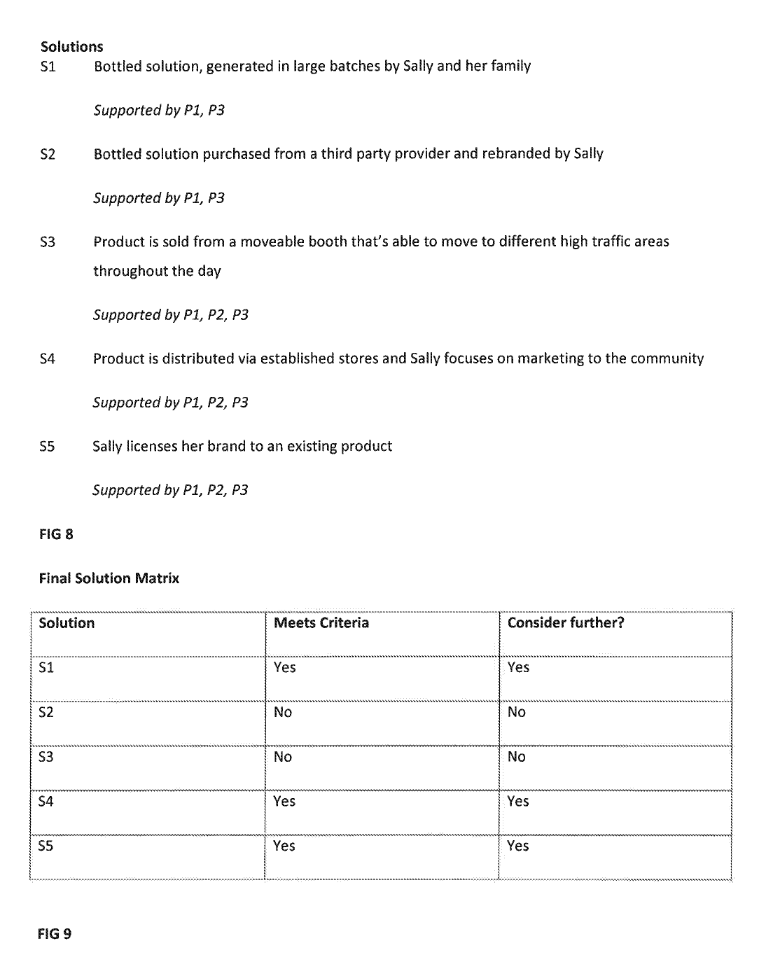

FIG. 9 shows the result of the reviewing and striking substeps indicated above; herein it will be seen that solutions S2, and S3 failed to meet the criterion.

The result of the method is possible solutions to problem that merit further consideration.

This has been used with over 700 people in over 120 companies.

In that time it has been estimated that over 3000 insights have been generated.

In greater than 80% of the cases the participants of the exercise have indicated that the insights generated were different than they had reached by using traditional methods such as brainstorming.

Whereas a single exemplary embodiment is illustrated, it will be obvious that variations are possible.

For example, whereas in the exemplary embodiment, both Investigate and Integrate steps were conducted, this is not essential. The Investigate step, for example, could be omitted, particularly if time was constrained.

Further, whereas the exemplary method is described to be for use with a group, this is not necessary.

Additionally, whereas the factor selection process was carried out using a specific ranking methodology, this methodology is not required.

As well, whereas in the exemplary embodiment, the members of the user group adopt viewpoints different than their own for the Navigate process, it will be understood that modified viewpoints can be used throughout the process.

Further, although the description indicated above merely mentions that different viewpoints may be adopted, and provides the results of a prophetic example, it should be understood that in the context of facilitated sessions, the facilitator may test the members of the user group to improve the likelihood that the responses generated are indeed reflective of the selected viewpoint. Techniques such as listening for the use of past tense and specific words or phrases can help the facilitator decide if the group is well rooted in the selected viewpoint or needs more time and guidance to enter the mindset.

Accordingly, the invention should be understood as limited only by the accompanying claims, purposively construed.

1. A method for use with a problem, the method comprising activity on the part of the user structured to include:
a locate step involving
a definition of the problem; and
ideation of factors that are material to the problem or to the utility of possible solutions to the problem,
a navigate step following the locate step and involving
a ranking of the factors in terms of the importance of the factor to the problem and the extent to which the factor can be controlled;
a selection amongst the factors of factors that are relatively more important and/or relatively more susceptible to control, than the others;
a review of the selected factors to identify viewpoints related to the factors; and
a review of the selected factors from the identified viewpoints to ideate a body of insights.

2. A method according to claim 1, wherein the activity is structured to further include an integrate step following the navigate step, the integrate step involving:
a review of the generated insights to ideate patterns and connections;
ideation of possible solutions to the problem; and
reviewing the possible solutions for merit to select solutions for further consideration.

3. A method according to claim 2, wherein, the integrate step involves identification of criteria which must be met in order to constitute a viable solution and the review of the possible solutions for merit involves the de-selection of those that fail to address the criteria.

4. A method according to claim 3, wherein the activity is structured to further include an investigate step preceding the integrate step, the investigate step involving:
in respect of each insight, a determination of importance and a determination as to the level of confidence in the accuracy of each insight;
an effort to verify insights determined to be relatively important and in respect of which there exists relatively low confidence as to accuracy; and
removal of insights from the body that have been proven inaccurate as part of the verification effort.

5. A method according to claim 1, wherein in the navigate step, the relationship between the viewpoint and the factor
is relatively close when the factor has been relatively lightly explored; and
is relatively distant when the factor has been relatively heavily explored.

6. A method according to claim 5, wherein the viewpoint that is relatively close to the factor is the viewpoint of the factor.

7. A method according to claim 6, wherein the relatively distant relationship between the factor and the viewpoint is a relationship defined by time, space or pattern.
